(19) United States
(12) Patent Application Publication
(10) Pub. No.: US 2006/0213543 A1
(43) Pub. Date: Sep. 28, 2006

(54) Conveyor-type dishwasher and method for it

(76) Inventors: Jurgen Litterst, Appenweier (DE); Werner Neumaier, Offenburg (DE); Dietrich Berner, Waldstetten (DE); Klaus Padtberg, Offenburg (DE); Harald Disch, Elzach (DE)

Correspondence Address: THOMPSON HINE LLP, P.O Box 8801, DAYTON, OH, 45401-8801, US

(21) Appl. No.: 11/387,004

(22) Filed: Mar. 22, 2006

(30) Foreign Application Priority Data
Mar. 24, 2005 (DE) 102005014353.9

(51) Int. Cl. B08B 7/04; B08B 9/20; B08B 3/00

(52) U.S. Cl. 134/103.2; 134/56 D; 134/137; 134/151; 134/198; 134/94.1; 134/124; 134/131; 134/18; 134/25.2

(57) ABSTRACT

Conveyor-type dishwasher comprising a conveying apparatus having compartments which extend transverse to the conveying direction and serve to hold items to be washed. A rinse zone has at least one transversely directed lateral spray nozzle on at least one side each for spraying rinsing liquid onto the item to be washed. Furthermore, a sensor apparatus for items to be washed is provided for detecting empty compartments from among the large number of compartments of the conveying apparatus. A control apparatus is provided to automatically switch off the supply of rinsing liquid to at least some of the lateral spray nozzles of the rinse zone as a function of detected empty compartments, and to automatically switch on the supply of rinsing liquid to at least some of the lateral spray nozzles as a function of detected compartments which contain items to be washed.

The invention relates to a conveyor-type dishwasher and to a method for operating a conveyor-type dishwasher of this kind.

Accordingly, the invention relates in particular to a flight-type dishwasher or a rack-conveyor dishwasher.

Conveyor-type dishwashers are used in the commercial sector. In contrast to domestic dishwashers in which the items to be cleaned remain fixed in position in the machine during cleaning, in the case of conveyor-type dishwashers the item to be washed is conveyed through various spray zones of the conveyor-type dishwasher.

A conveyor-type dishwasher of the kind described in the preamble of claim 1 is known in practice. U.S. Pat. No. 5,497,798 discloses providing lateral spray nozzles in a cleaning zone of a conveyor-type dishwasher. US-A-2002/0020435 discloses detecting various types of items to be washed by detecting various types of racks in which the various types of items to be washed are sorted. A washing or rinsing program is selected depending on the type of item to be washed which is detected in this way.

DE 196 08 030 C1 relates to a cleaning machine, in particular for dishes, in which the length of an area of action can be set at least as a function of the item to be washed by it being possible to connect or disconnect parts of the existing spraying systems.

DE 196 08 036 C1 discloses a cleaning machine, in particular for dishes, in which the amount of fresh water which is sprayed for rinsing, and the amount of rinse aid can each be set to at least two different values as a function of the conveying speed of the conveying apparatus.

The object of the invention is to provide a conveyor-type dishwasher which consumes less water, fewer chemicals and less energy.

According to the invention, this object is achieved by claim 1.

It is possible to reduce the consumption of fresh water, which in the rinsing zone is sprayed onto the item to be washed in pure form or admixed with further additives, by providing a sensor apparatus for items to be washed in order to detect empty compartments from among the large number of compartments of the conveying apparatus, and by providing a control apparatus to automatically switch off the supply of rinsing liquid to at least some of the lateral spray nozzles of the rinsing zone as a function of detected empty compartments. The reduced consumption of fresh water in the conveyor-type dishwasher can also reduce the consumption of chemicals, in particular rinse aid and/or cleaner, without causing a change in the chemical concentration in the respective liquid. The lower supply of fresh water reduces the amount of water which needs to be heated, thus saving energy.

Further features of the invention are to be found in the subclaims.

The invention is described in the text which follows with reference to the drawings using preferred embodiments as examples.

In the drawings

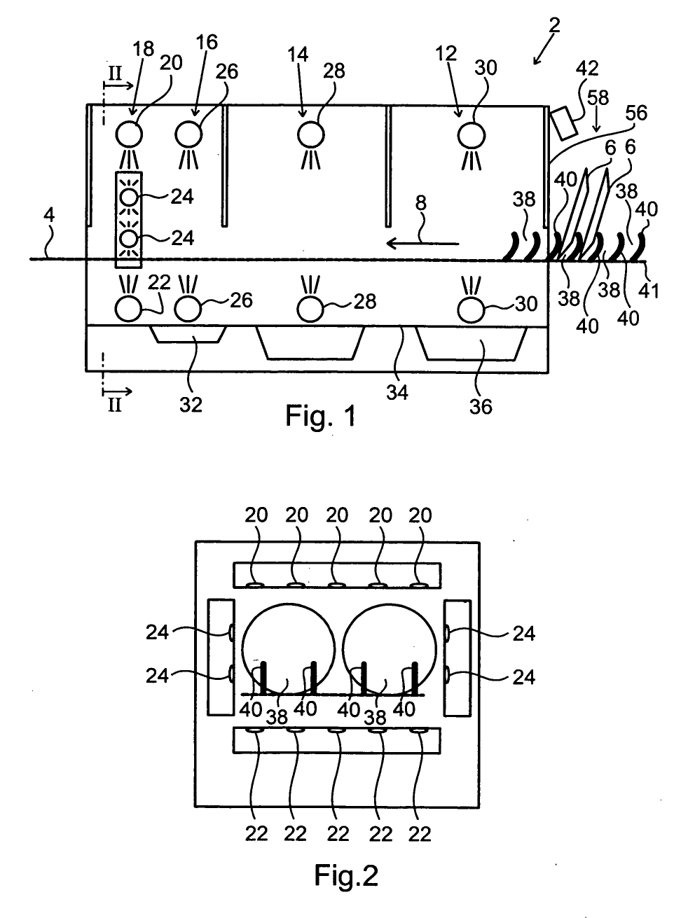

FIG. 1 is a view of a longitudinal section through a conveyor-type dishwasher according to the invention;

FIG. 2 is a cross-sectional view along line II-II in FIG. 1;

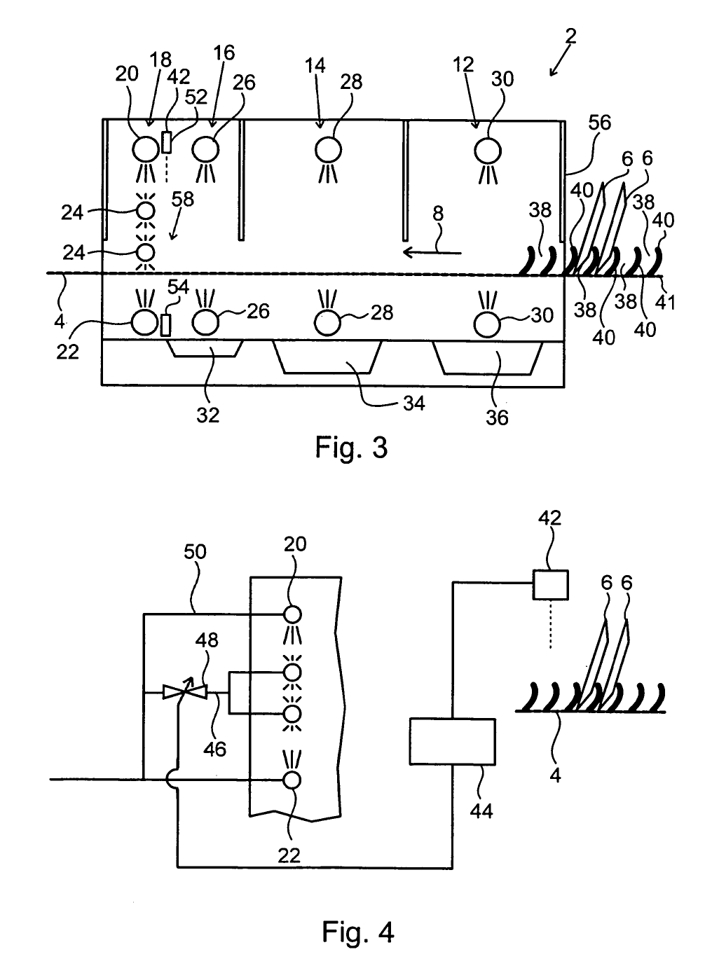

FIG. 3 shows a further embodiment of a conveyor-type dishwasher according to the invention;

FIG. 4 schematically shows part of a conveyor-type dishwasher according to the invention;

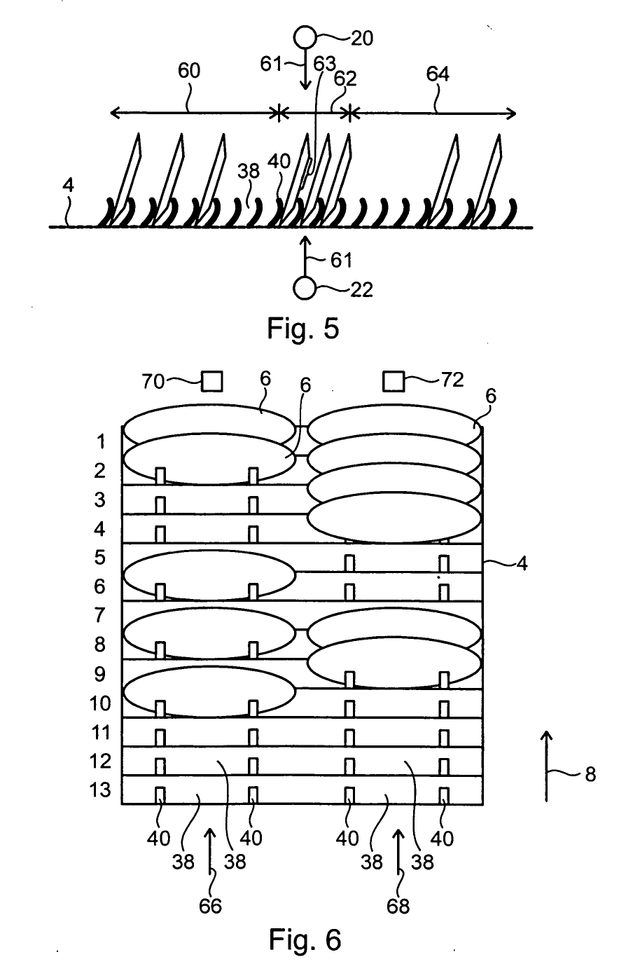

FIG. 5 shows a conveying apparatus of one embodiment of a conveyor-type dishwasher according to the invention with items to be washed arranged on it; and

FIG. 6 is a plan view of a conveying apparatus of one embodiment of a conveyor-type dishwasher according to the invention.

FIG. 1 shows a conveyor-type dishwasher 2 having a conveying apparatus 4 for conveying items 6 to be washed through the conveyor-type dishwasher 2 in a conveying direction 8. The conveyor-type dishwasher 2 has at least one cleaning or wash zone, for example as illustrated in FIG. 1, a precleaning or prewash zone 12 and a main cleaning or wash zone 14 which is arranged downstream of the precleaning zone 12 as seen in the conveying direction 8.

A subsequent cleaning zone 16 generally referred to as a post-wash or pre-rinse zone 16 is arranged downstream of the at least one cleaning zone 12, 14 as seen in the conveying direction 8. At least one, for example as illustrated only a single rinse zone 18 is arranged downstream of the subsequent cleaning zone 16 as seen in the conveying direction 8.

The said zones of the conveyor-type dishwasher 2 have associated spray nozzles 20, 22, 24, 26, 28, 30 for spraying liquid onto the item 6 to be washed which is conveyed through the respective zone 12, 14, 16, 18 by the conveying apparatus 4. Each of the zones 12, 14, 16, 18 has an associated tank 32, 34, 36 for collecting liquid which has been sprayed and/or for providing liquid for the spray nozzles of the relevant zone. In the case of the conveyor-type dishwasher 2 illustrated in FIG. 1, rinsing liquid in the form of fresh water, which can be pure or admixed with further additives such as rinse aid, is sprayed onto the item 6 to be washed by means of the spray nozzles 20, 22, 24 of the rinsing zone 18.

The rinsing liquid which has been sprayed is conveyed from zone to zone via a cascade system in the opposite direction to the conveying direction 8 of the item to be washed.

The rinsing liquid which has been sprayed is collected in the tank 32 of the cleaning, post-wash or pre-rinse zone 16 and from here it is delivered to the spray nozzles 26 of the subsequent cleaning zone 16 via a pump system (not illustrated). Cleaning liquid is rinsed off from the item 6 to be washed in the subsequent cleaning zone 16. The liquid produced as a result of this flows into the tank 34 of the main cleaning zone 14, a cleaning aid is added and the resulting liquid is sprayed onto the item 6 to be washed through a pump system (not illustrated) by means of the nozzles 28 of the main cleaning zone 14. Liquid flows into the tank 36 of the precleaning zone 12 from the tank of the main cleaning zone 14. The liquid in this tank 36 is sprayed onto the item 6 to be washed via a pump system (not illustrated) by means of the nozzles 30 of the precleaning or pre-wash zone 12 in order to remove heavy soiling from the item 6 to be washed.

The conveying apparatus 4 has compartments 38 which extend transverse to the conveying direction 8 and serve to hold items 6 to be washed. In the illustrated embodiments of a conveyor-type dishwasher 2, the compartments 38 are formed by supporting fingers 40 on a conveyor belt 41 of the conveying apparatus 4. As an alternative, the compartments 38 may, for example, be formed in racks in a rack-conveyor dishwasher.

The rinsing zone 18 has downwardly directed upper spray nozzles 20, upwardly directed lower spray nozzles 22 and two transversely directed lateral spray nozzles 24 on either side of the conveying apparatus 4.

Contemporary flight-type/rack-conveyor dishwashers operate mainly with upper and lower spray nozzles in the rinsing zone. Experiments have shown that the use of lateral or side rinsing nozzles results in targeted “scanning” of the dish surfaces even in shadow zones. The use of lateral nozzles has a distinct advantage over conventional systems in terms of subsequent washing performance (guaranteed rinsing off of cleaning aid residues from the surfaces of the dishes even in shadow zones), particularly when the conveyor belt is fully occupied, that is to say when the belt is loaded plate to plate.

A conveyor-type dishwasher according to the invention is characterized in that a sensor apparatus 42 for items to be washed is provided for detecting empty compartments 38 from among the large number of compartments 38 of the conveying apparatus 4. The sensor apparatus 42 for items to be washed may, for example, have at least one camera and/or at least one optical sensor and/or at least one light barrier.

Furthermore, a control apparatus 44 is provided according to the invention to automatically switch off the supply of rinsing liquid of at least some of the lateral spray nozzles 24 of the rinsing zone 18 as a function of detected empty compartments 38. The supply of fresh water to the conveyor-type dishwasher is reduced by switching off the relevant lateral spray nozzles 24 of the rinsing zone 18, thus saving water, chemicals and energy.

Detecting the empty compartments 38 means a state can be detected in which there are no shadow zones between the individual dish elements with respect to the upper spray nozzles 20 and the lower spray nozzles 22 of the rinsing zone 18. In this case, according to the invention, the supply of rinsing liquid to the lateral rinsing nozzles is switched off since it is possible to rinse off cleaning aid residues from the surfaces of the dishes even without the lateral rinsing nozzles 24, so that switching off the relevant lateral rinsing nozzles 24 results in reduced water consumption with the same washing result.

According to the invention, the control apparatus 44 is designed to automatically switch on the supply of rinsing liquid to at least some of the lateral spray nozzles 24 as a function of detected compartments 38 which contain items 6 to be washed. According to the embodiment illustrated in FIG. 4, a rinsing liquid supply line 46 to the lateral spray nozzles 24 contains a controllable valve 48 which can be controlled by the control apparatus 44. The rinsing liquid supply line 46 to the lateral spray nozzles is connected to a rinsing liquid supply line 50 to the upper rinsing nozzles 20. As an alternative, the rinsing liquid supply line 46 can be connected in any other desired manner, for example to a further rinsing liquid supply line or to a rinsing liquid reservoir.

In the embodiment of a conveyor-type dishwasher 2 of the invention illustrated in FIG. 3, the sensor apparatus 42 for items to be washed is arranged at the start of the rinsing zone 18 as seen in the conveying direction 8. This has the advantage that the control apparatus 44 can switch off or switch on the lateral spray nozzles 24 directly, without a time delay, as a function of the detected compartments 38. The sensor apparatus 42 for items to be washed illustrated in FIG. 3 has at least one light barrier with a light transmitter 52 and a light receiver 54.

Furthermore, as illustrated in FIG. 1, the sensor apparatus 42 for items to be washed can be arranged at a defined distance upstream of the rinsing zone 18 as seen in the conveying direction 8. In this embodiment, the sensor apparatus 42 for items to be washed is arranged upstream of the first cleaning zone 12 as seen in the conveying direction, in this case in the region of an entrance 56 to the conveyor-type dishwasher 2. The control apparatus 44 is in this case designed to switch on or switch off the supply of rinsing liquid as a function of the detected compartments 38 when these are in the rinsing zone 18.

For this purpose, the control apparatus 44 is designed to switch on or switch off the supply of rinsing liquid a predetermined period of time after the relevant compartments 38 are detected, wherein the predetermined period of time is a function of the speed of the conveying apparatus 4 and is determined by the period of time that a compartment 38 respectively requires to get from the detection location 58 of the sensor apparatus 42 for items to be washed to the rinsing zone 18. This ensures that the supply of liquid to the lateral spray nozzles 24 of the rinsing zone 18 is in each case correctly switched off or switched on independently of the arrangement of the sensor apparatus 42 for items to be washed with regard to the rinsing zone 18 when the relevant detected compartment 38 is in the rinsing zone 18.

As an alternative, provision may be made for the conveying apparatus 4 to be designed for cyclical operation, and for the control apparatus 44 to be designed to switch on or switch off the supply of rinsing liquid to the lateral rinsing nozzles 24 a predetermined number of cycle steps after the relevant compartments 38 are detected, wherein the predetermined number of cycle steps is determined by the number of cycle steps which a compartment 38 respectively requires to get from the detection location 58 of the sensor apparatus 42 for items to be washed to the rinsing zone 18.

The control apparatus 44 of the embodiment of a conveyor-type dishwasher 2 illustrated in FIG. 1 is designed to switch on the supply of rinsing liquid when an occupied compartment 38 passes into the rinsing zone 18. For example, the control apparatus 44 may be designed to switch on the supply of rinsing liquid to the lateral rinsing nozzles 24 as an occupied compartment 38 begins to enter the rinsing zone 18. Furthermore, the control apparatus 44 may be designed to switch on the supply of rinsing liquid to the lateral rinsing nozzles 24 when an occupied compartment 38 has completely entered the rinsing zone 18. FIG. 5 shows, by way of example, a possible way in which the conveying apparatus 4 may be occupied. In a first section 60 of the conveying apparatus 4, three plates are each in a compartment 38 of the conveying apparatus 4. There is an empty compartment 38 between each of these plates. As explained above, the control device 44 may be designed to switch on the lateral rinsing nozzles 24 for each occupied compartment and to switch off the lateral rinsing nozzles for each empty compartment, with the result that the supply of rinsing liquid to the lateral rinsing nozzles 24 is correspondingly switched on and off in the following order “on-off-on-off-on-off-off-off” in the case of the first section 60 being occupied as illustrated in FIG. 5.

The control apparatus 44 may furthermore be designed to switch on the supply of rinsing liquid to the lateral rinsing nozzles 24 when a first occupied compartment 38 of a group of at least two successive occupied compartments 38 is in the rinsing zone 18. As can be seen in FIG. 5, no shadow zones with respect to the upper spray nozzles 20 and the lower spray nozzles 22 of the rinsing zone 18 are produced in the first section 60 on account of the empty compartments 38 between the compartments occupied with plates. This is not the case in the second section 62 of the conveying apparatus 4 in FIG. 5. Here, three plates are arranged in respectively successive compartments 38. In this way, shadow zones 63 are produced on the plates, the spray jet 61 from the upper spray nozzles 20 and lower spray nozzles 22 not being able to reach these shadow zones directly. A shadow zone 63 is illustrated in FIG. 5 on a rear face of a plate by way of example. It goes without saying that there is also a shadow zone on the opposite front face of the plate in the directly successive compartment. In order to prevent cleaning aid residues, according to the invention a supply of liquid to at least one lateral spray nozzle 24 (not illustrated in FIG. 5) is switched on in this case. In this way, guaranteed rinsing off of cleaning aid residues can be ensured even if the belt is loaded plate to plate, without too much rinsing liquid unnecessarily being sprayed when the belt is not fully loaded. In consequence, when the belt is loaded as illustrated in FIG. 5, the supply of rinsing liquid to the lateral spray nozzles 24 is switched off when the first section 60 of the conveying apparatus 4 passes through the rinsing zone, is switched on when the second section 62 of the conveying apparatus 4 passes through the rinsing zone, and is switched off again when the third section 64 of the conveying apparatus 4 passes through the rinsing zone.

FIG. 6 shows, by way of example, two rows of in each case thirteen compartments 38 of the conveying apparatus 4 arranged in series in the conveying direction 8. The sensor apparatus 42 for items to be washed may be designed to separately detect the left-hand half 66 of the conveying apparatus 4 and the right-hand half 68 of the conveying apparatus 4 as seen in the conveying direction 8. This is particularly advantageous when the conveying apparatus 4 is wide enough and is designed to hold two rows of items 6 to be washed, for example two rows of plates, as illustrated in FIG. 6. In this case, the sensor apparatus 42 for items to be washed has a sensor part 70 which is associated with the left-hand half 66 of the conveying apparatus 4 and a sensor part 72 which is associated with the right-hand half 68 of the conveying apparatus 4. In this context, the term “sensor part” refers to a part of the sensor apparatus 42 for items to be washed which is associated with the respective half of the conveying apparatus 4 and can be formed by a common sensor apparatus, for example a common camera, or, as illustrated in FIG. 6, by two separate sensor apparatus parts, for example two light barriers. The control apparatus 44 is in this case designed to switch on and switch off the supply of rinsing liquid to the lateral rinsing nozzles 24 on the left-hand side of the rinsing zone 18 as a function of the sensor part 70 which is associated with the left-hand side and detects the left-hand half 66 of the conveying apparatus 4. Furthermore, the control apparatus 44 is designed to switch on and switch off the supply of rinsing liquid to the lateral rinsing nozzles 24 on the right-hand side of the rinsing zone 18 as a function of the sensor part 72 which is associated with the right-hand side and detects the right-hand half 68 of the conveying apparatus 4.

Detecting the left-hand half 66 and the right-hand half 68 of the conveying apparatus 4 separately has the advantage that the lateral rinsing nozzles 24 can be switched off and switched on in an optimum manner even if the left-hand half 66 and the right-hand half 68 are loaded differently.

The invention is not restricted to the embodiments of FIG. 1 to FIG. 6 shown by way of example in the drawings. The invention is rather the result of an overall consideration by a person skilled in the art after review of the claims, the description, the exemplary embodiments and the variants mentioned below which are intended to provide the person skilled in the art with information about further possible embodiments, which fall within the scope of the claims, without however restricting the possible variants to this information.

The sensor apparatus 42 for items to be washed can have sensor parts which are arranged at a distance from one another as seen in the conveying direction 8.

The sensor apparatus 42 for items to be washed may be designed to register the type of items to be washed. For example, the sensor apparatus 42 for items to be washed can have at least one camera for this purpose in order to detect the type of items to be washed. In this way, it is possible to register, depending on the type of items to be washed, a state in which the item 6 to be washed has shadow zones 63 with respect to the upper spray nozzles 20 and the lower spray nozzles 22.

The sensor apparatus 42 for items to be washed may be designed to detect plates which have a relatively large surface to be cleaned for each occupied compartment 38 of the conveying apparatus 4, and to detect large items 6 to be washed, such as pots, containers and boxes, which have a relatively small surface to be cleaned for each occupied compartment 38. This makes it possible to switch on or switch off the lateral rinsing nozzles 24 as a function of a sum total of the surfaces to be cleaned for each unit of time. The sum total of surfaces to be cleaned per unit of time is in this case a measure of the possible occurrence of shadow zones 63 with respect to the lower and the upper spray nozzles 20 of the rinsing zone 18.

In accordance with the fact that the control apparatus 44 controls the supply of rinsing liquid to the lateral rinsing nozzles 24 as a function of a sum total of the surfaces to be cleaned for each unit of time, provision may also be made for the control apparatus 44 to additionally take into account the conveying speed of the conveying apparatus 4 in order to decide whether the supply of liquid to one or more lateral rinsing nozzles 24 will be switched off or switched on.

1. Conveyor-type dishwasher comprising a conveying apparatus for conveying items to be washed through at least one wash zone and at least one rinse zone, wherein the conveying apparatus has a plurality of compartments which extend transverse to the conveying direction and serve to hold items to be washed, and wherein the rinse zone has downwardly directed upper spray nozzles, upwardly directed lower spray nozzles and at least one transversely directed lateral spray nozzle on at least one side each for spraying rinsing liquid onto items to be washed, characterized in that a sensor apparatus for items to be washed is provided for detecting empty compartments from among the plurality of compartments of the conveying apparatus, and in that a control apparatus is provided to automatically switch off the supply of rinsing liquid to at least one lateral spray nozzle of the rinse zone as a function of detected empty compartments, and to automatically switch on the supply of rinsing liquid to at least one lateral spray nozzle as a function of detected compartments which contain items to be washed.

2. Conveyor-type dishwasher according to claim 1, characterized in that the sensor apparatus for items to be washed is arranged at the start of the rinse zone as seen in the conveying direction.

3. Conveyor-type dishwasher according to claim 1, characterized in that the sensor apparatus for items to be washed is arranged at a defined distance upstream of the rinse zone as seen in the conveying direction, and in that the control apparatus is designed to switch on or switch off the supply of rinsing liquid as a function of when the detected compartments are in the rinse zone.

4. Conveyor-type dishwasher according to claim 3, characterized in that the control apparatus is designed to switch on or switch off the supply of rinsing liquid a predetermined period of time after the relevant compartments are detected, wherein the predetermined period of time is a function of the speed of the conveying apparatus and is determined by the period of time that a compartment respectively requires to get from the detection location of the sensor apparatus for items to be washed to the rinse zone.

5. Conveyor-type dishwasher according to claim 3, characterized in that the conveying apparatus is designed for cyclical operation, and in that the control apparatus is designed to switch on or switch off the supply of rinsing liquid a predetermined number of cycle steps after the relevant compartments are detected, wherein the predetermined number of cycle steps is determined by the number of cycle steps which a compartment respectively requires to get from the detection location of the sensor apparatus for items to be washed to the rinse zone.

6. Conveyor-type dishwasher according to claim 1, characterized in that the control apparatus is designed to switch on the supply of rinsing liquid when an occupied compartment passes into the rinse zone.

7. Conveyor-type dishwasher according to claim 1, characterized in that the control apparatus is designed to switch on the supply of rinsing liquid when a first occupied compartment of a group of at least two successive occupied compartments is in the rinse zone.

8. Conveyor-type dishwasher according to claim 1, characterized in that at least one lateral spray nozzle is arranged on each of the two sides of the rinse zone, in that the sensor apparatus for items to be washed is designed to separately detect the left-hand half of the conveying apparatus and the right-hand half of the conveying apparatus as seen in the conveying direction, and in that, for this purpose, the sensor apparatus for items to be washed has a sensor part which is associated with the left-hand half of the conveying apparatus and a sensor part which is associated with the right-hand half of the conveying apparatus, in that the supply of rinsing liquid to the at least one lateral spray nozzle on the left-hand side of the rinsing zone is switched on and switched off as a function of the sensor part which is associated with the left-hand side and detects the left-hand half of the conveying apparatus, and in that the supply of rinsing liquid to the at least one lateral spray nozzle on the right-hand side of the rinse zone is switched on and switched off as a function of the sensor part which is associated with the right-hand side and detects the right-hand half of the conveying apparatus.

9. Method for operating a conveyor-type dishwasher for washing items to be washed, comprising a conveying apparatus for conveying items to be washed through at least one cleaning spray zone and at least one rinsing zone in a conveying direction, wherein the conveying apparatus has a plurality of compartments which extend transverse to the conveying direction and serve to hold items to be washed, and wherein the rinse zone has downwardly directed upper spray nozzles, upwardly directed lower spray nozzles and at least one transversely directed lateral spray nozzle on at least one side each for spraying rinsing liquid onto items to be washed, characterized in that empty compartments are detected from among the plurality of compartments of the conveying apparatus, and in that the supply of rinsing liquid to at least one lateral spray nozzle of the rinse zone is automatically switched off as a function of detected empty compartments, and the supply of rinsing liquid to at least one lateral spray nozzle is automatically switched on as a function of detected compartments which contain items to be washed.

10. Conveyor-type dishwasher according to claim 1, characterized in that when the control apparatus automatically switches off the supply of rinsing liquid to at least one lateral spray nozzle as a function of detected empty compartments, the supply of rinsing liquid to at least some of the upper spray nozzles and at least some of the lower spray nozzles is maintained on.

11. Method for operating a conveyor-type dishwasher according to claim 9, characterized in that when the supply or rinsing liquid to at least one lateral spray nozzle is automatically switched off as a function of detected empty compartments, the supply of rinsing liquid to at least some of the upper spray nozzles and at least some of the lower spray nozzles is maintained on.
